(19) United States
(12) Patent Application Publication
(10) Pub. No.: US 2009/0168708 A1
(43) Pub. Date: Jul. 2, 2009

(54) TECHNIQUES FOR MAINTAINING QUALITY OF SERVICE FOR CONNECTIONS IN WIRELESS COMMUNICATION SYSTEMS

(75) Inventors: Prachi P. Kumar, Palatine, IL (US); Gregory M. Agami, Arlington Heights, IL (US); Jiangnan Jason Chen, Hawthorn Woods, IL (US); Mark J. Marsan, Elmhurst, IL (US); Trang K. Nguyen, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/258,527

(22) Filed: Oct. 27, 2008

Related U.S. Application Data
(60) Provisional application No. 61/016,616, filed on Dec. 26, 2007.

(51) Int. Cl. H04W 28/00

(52) U.S. Cl. 370/329

(57) ABSTRACT

A technique for operating a wireless communication device includes assigning re-transmission identifiers, such as hybrid automatic repeat request (HARQ) channel identifications, automatic repeat request (ARQ) channel identifications, and ARQ Identifier Sequence Numbers, to at least a first re-transmission identifier group and a second re-transmission identifier group, wherein each re-transmission identifier group is associated with a different quality of service parameter. The technique identifies whether a committed quality of service is met for a connection based on whether a communication on the connection is associated with the first re-transmission identifier group or the second re-transmission identifier group.

### CROSS-REFERENCE TO RELATED APPLICATION

This application claims priority from provisional application Ser. No. 61/016,616, attorney docket no. CE17322N4V, entitled “TECHNIQUES FOR MAINTAINING QUALITY OF SERVICE FOR CONNECTIONS IN WIRELESS COMMUNICATION SYSTEMS,” and filed Dec. 26, 2007, which is commonly owned and incorporated herein by reference in its entirety.

### BACKGROUND

1. Field

This disclosure relates generally to wireless communication systems and, more specifically, to techniques for maintaining quality of service for connections in wireless communication systems.

2. Related Art

Today, many wireless communication systems are designed using shared channels. For example, in the Institute of Electrical and Electronics Engineers (IEEE) 802.16 (commonly known as worldwide interoperability for microwave access (WiMAX)) and third-generation partnership project long-term evolution (3GPP-LTE) compliant architectures, an uplink (UL) channel is shared and resources may be periodically allocated to individual service flows (connections) in the case of delay sensitive (e.g., real-time) applications (e.g., Voice over Internet Protocol (VoIP) applications).

In WiMAX compliant wireless communication systems, a quality of service (QoS) parameter set is defined for each service flow, which is a unidirectional flow of packets between a subscriber station (SS) and a serving base station (BS) and vice versa. Each service flow has an assigned service flow identification (SFID), which functions as a principal identifier for the service flow between an SS and a serving BS. In WiMAX compliant wireless communication systems, scheduling services represent the data handling mechanisms supported by a medium access control (MAC) scheduler for data transport on a connection. Each connection is associated with a single scheduling service, which is determined by a set of QoS parameters that are managed using dynamic service addition (DSA) and dynamic service change (DSC) message dialogs. IEEE 802.16e compliant wireless communication systems support a number of different data services. For example, IEEE 802.16e compliant wireless communication systems are designed to support unsolicited grant service (UGS), real-time polling service (rtPS), extended real-time polling service (ertPS), non-real-time polling service (nrtPS), and best effort (BE) service.

Today, various wireless communication systems employ an automatic repeat request (ARQ) error control procedure for data transmission. In an ARQ error control procedure, error detection (ED) information (e.g., cyclic redundancy check (CRC) bits) are added to data to be transmitted. In general, an ARQ error control procedure employs acknowledgments and timeouts to achieve reliable data transmission. An acknowledgment is a message sent by a first wireless communication device to a second wireless communication device to indicate that the first wireless communication device has correctly received a data frame transmitted by the second wireless communication device. If the second wireless communication device does not receive an acknowledgment before expiration of a timeout period, the second wireless communication device usually re-transmits the data frame until it receives an acknowledgment or the number of re-transmissions exceeds a predefined number of re-transmissions. An ARQ protocol may employ a stop-and-wait mode, a go-back-N mode, or a selective repeat mode.

A hybrid automatic repeat-request (HARQ) error control procedure is a variation of the ARQ error control procedure that is also employed in various wireless communication systems. In general, a HARQ error control procedure provides better performance than an ARQ error control procedure in poor signal conditions. In type I HARQ, both ED and forward error correction (FEC) information (such as Reed-Solomon code or turbo code) is added to each message prior to transmission. In type II HARQ, which is more sophisticated than type I HARQ, either ED bits or FEC information and ED bits are transmitted on a given transmission. In general, ED only adds a couple of bytes to a message which is relatively insignificant for relatively long messages, e.g., messages having a length of twenty bytes or more. FEC, on the other hand, can often double or triple a message length with error correction parities for relatively short messages, e.g., messages have a maximum length of six bytes.

In an ARQ error control procedure, a transmission must be received error free for the transmission to pass error detection. In a type II HARQ error control procedure, a first transmission contains only data and error detection (which is the same as ARQ). If a message is received error free, no re-transmission is required. However, if a message is received with one or more errors, a re-transmission of the message includes both FEC parities and ED bits. If the re-transmission is received error free, no further action is required. If the re-transmission is received in error, error correction can be attempted by combining the information received from both the original transmission and the re-transmission. In general, type I HARQ experiences capacity loss in strong signal conditions and type II HARQ does not, because FEC bits are only transmitted on subsequent re-transmissions. In strong signal conditions, type II HARQ capacity is comparable to ARQ capacity. In poor signal conditions, type II HARQ sensitivity is comparable with ARQ sensitivity. In general, the stop-and-wait mode is simpler, but has reduced efficiency. As such, when the stop-and wait mode is employed, multiple stop-and-wait HARQ processes are often performed in parallel. In this case, when one HARQ process is waiting for an acknowledgment, another HARQ process can use the channel to send data.

HARQ error control procedures may employ chase combining (CC) or incremental redundancy (IR) for transmitting coded data packets. In CC, incorrectly received coded data blocks are stored (rather than be discarded), and when the re-transmitted block is received, the blocks are combined, which can increase the probability of successful transmission decoding. For downlink HARQ error control, a serving BS transmits an encoded HARQ packet to a subscriber station (SS). The SS receives the encoded packet and attempts to decode the encoded packet. If the decoding is successful, the SS sends an acknowledgement (ACK) to the BS. If the decoding is not successful, the SS sends a negative acknowledgement (NAK) to the BS. In response, the BS sends another HARQ attempt. The BS may continue to send HARQ attempts until the SS successfully decodes the packet and sends an acknowledgement. For uplink HARQ error control the process is substantially the reverse of downlink HARQ error control.

In general, support for quality of service (QoS) is a fundamental part of a WiMAX medium access control (MAC) layer design. QoS control is achieved by using a connection-oriented MAC architecture in which all downlink and uplink connections are controlled by a serving BS. Before any data transmission occurs, a BS and an SS establish a unidirectional logical link, called a connection, between two MAC layer peers (one in the BS and one in the SS). Each connection is identified by a connection identifier (CID), which serves as a temporary address for data transmissions over the connection. WiMAX also defines the concept of a service flow, which is a unidirectional flow of packets with a particular set of QoS parameters that is identified by a service flow identifier (SFID). QoS parameters may include, for example, traffic priority, maximum sustained traffic rate, maximum burst rate, minimum tolerable rate, scheduling type, ARQ type, maximum delay, tolerated jitter, service data unit (SDU) type and size, bandwidth request mechanism to be used, and transmission protocol data unit (PDU) formation rules. Service flows may be provisioned through a network management system or created dynamically through defined signaling mechanisms. The serving BS is responsible for issuing an SFID and mapping it to a unique CID.

In various wireless communication systems that employ multiple-access technology, an arbitrator has usually been implemented to schedule access to shared resources (e.g., a shared uplink (UL)). In at least some wireless communication systems, SSs (e.g., mobile stations (MSs)) share a UL on a demand basis and a scheduler (e.g., a BS scheduler or a network scheduler in communication with a BS) ensures a committed quality of service (QoS) for all admitted flows in the system. In a typical wireless communication system that employs multiple-access technology, a BS attempts to manage QoS to maximize end-to-end user communication (as SSs are not usually aware of system constraints). In order to maintain QoS in high-capacity, high-bandwidth grant-per-SS systems, such as IEEE 802.16d/e communication systems, decisions made by a serving BS are enforced on served SSs.

In IEEE 802.16d/e systems, as well as other grant-per-SS systems, while UL grants are SS based, QoS is connection-based. For example, in IEEE 802.16d/e systems, UL bandwidth requests reference individual UL connections, while each bandwidth grant is addressed to a basic MAC management connection (or basic connection identifier (CID)) of an SS, in contrast to non-basic (or individual) CIDs. As it is usually indeterminable which bandwidth request is being honored, when an SS receives a transmission opportunity (e.g., a data grant information element (IE)) directed at a basic CID of the SS, the SS may choose to transmit data for any active connection. In this way, UL connection QoS for SS-based-granting systems is flawed as a serving BS cannot usually unambiguously determine to which non-basic CID a received transmission belongs (i.e., when more than one non-basic CID is active for an SS).

According to IEEE 802.16d/e HARQ error control procedures, a data grant IE contains a HARQ channel ID (ACID) in addition to a basic CID of an SS. To maximize throughput and to minimize latencies, ACIDs have typically been setup as a shared resource across multiple connections that have varied QoS parameters, e.g., jitter requirements. In addition, in 802.16d/e compliant systems, a number of maximum re-transmissions for a UL HARQ burst at a physical (PHY) layer has been advertised in a broadcast message (in an uplink channel descriptor (UCD) message) and has been the same for all connection types and SSs. In this situation, it is possible that an attempt by a serving BS to reduce or meet jitter requirements on some jitter-intolerant flows may be futile. Moreover, a serving BS cannot ascertain which connection the SS has chosen until successful reception and may inappropriately continue to schedule re-transmissions for a jitter-intolerant flow. Furthermore, a scheduler may forego re-transmission attempts for a delay-insensitive flow if it incorrectly assumes the delay-insensitive flow is a jitter-intolerant flow.

With reference to FIGS. 1 and 2, example diagrams 100 and 200 depict a series of conventional communications between a conventional subscriber station (SS) and a conventional serving base station (BS) that employs a HARQ error control procedure. In the diagrams 100 and 200, the SS is executing a Voice over Internet Protocol (VoIP) application and a web browsing application. The SS has a basic CID of 1, all ACIDs (e.g., sixteen ACIDs) are available for any CID, and the BS is configured to provide a maximum of one re-transmission for VoIP traffic, a maximum of three re-transmissions for web browsing traffic, and a maximum of four re-transmissions for all other traffic. In a UL of a first frame 102, the BS receives a bandwidth request 101 from the SS for two connection identifiers (CIDs), i.e., a VoIP CID, for example, a CID 111, and a web browsing CID, for example, a CID 222. In a UL map of a second frame 104, the BS transmits a first allocation (HARQ subburst 1 for CID 111 having a basic CID 1; ACID 0; AISN (ARQ Identifier Sequence Number) 0) 103 for the VoIP CID 111 and a first allocation (HARQ subburst 2 for CID 222 having a basic CID 1; ACID 1; AISN 0) 105 for the web browsing CID 222. In a UL of a third frame 106, the SS transmits UL data for the web browsing CID 222 in a first grant 107 (which the BS allocated for the VoIP CID 111) and UL data for the VoIP CID 111 in a first grant 109 (which the BS allocated for the web browsing CID 222), as the SS can choose to send UL data for the VoIP CID 111 and the web browsing CID 222 in either of the grants 107 and 109.

Assuming that the UL data for the VoIP CID 111 and the web browsing CID 222 are received by the BS with CRC errors, the BS provides a second allocation 113 for the VoIP CID 111 and a second allocation 115 for the web browsing CID 222 in a UL map of a fourth frame 108. In a UL of a fifth frame 110, the SS re-transmits UL data for the web browsing CID 222 in a second grant 117 (which the BS allocated for the VoIP CID 111) and re-transmits UL data for the VoIP CID 111 in a second grant 119 (which the BS allocated for the web browsing CID 222). Assuming that the UL data for the VoIP CID 111 and the web browsing CID 222 are again received by the BS with CRC errors, the BS provides a third allocation 203 for the VoIP CID 111 in a UL map of a sixth frame 202 and abandons further re-transmissions for the web browsing CID 222, as the BS does not know that the SS transmitted the UL data for the VoIP CID 111 in the grant for the web browsing CID 222, and vice versa. In a UL of a seventh frame 204, the SS again re-transmits UL data for the VoIP CID 111 in a third grant 205. Assuming that the UL data for the VoIP CID 111 is again received with CRC errors, the BS provides a fourth allocation (third re-transmission) 207 for the VoIP CID 111 in a UL map of an eighth frame 206. As is illustrated, in a UL of a ninth frame 208, the SS again re-transmits UL data for VoIP CID 111 in a fourth grant 209. Assuming that the UL data for the VoIP CID 111 is received without error, the BS (upon decoding the received packet) determines that the re-transmissions for the VoIP CID 111 were over-scheduled (i.e., more than one re-transmission was scheduled) and the re-transmissions for the web browsing CID 222 were under-scheduled (i.e., less than three re-transmissions were scheduled).

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIGS. 1 and 2 are example diagrams that depict a series of conventional communications between a conventional subscriber station (SS) and a conventional serving base station (BS) that employs a HARQ error control procedure in accordance with the prior art.

FIGS. 3 and 4 are example diagrams that depict a series of communications between a subscriber station (SS) and a serving base station (BS) that employs a HARQ error control procedure according to the present disclosure.

FIG. 5 is a flowchart of an example process for maintaining quality of service for a connection in a wireless communication system according to the present disclosure.

FIG. 6 is a block diagram of an example wireless communication system that may be configured to maintain quality of service for a connection according to the present disclosure.

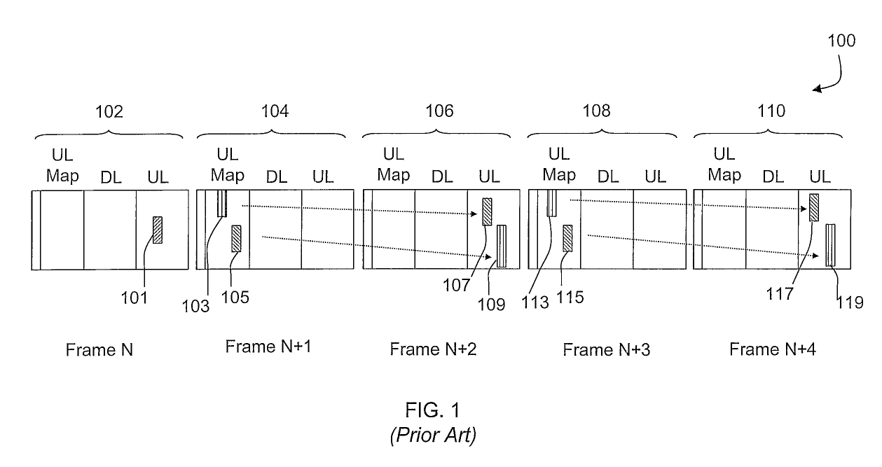

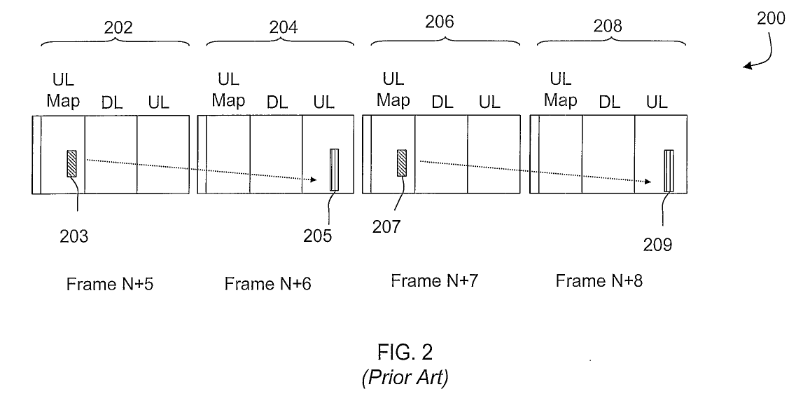

### DETAILED DESCRIPTION

In the following detailed description of exemplary embodiments of the invention, specific exemplary embodiments in which the invention may be practiced are described in sufficient detail to enable those of ordinary skill in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims and their equivalents.

While the discussion herein is generally directed to a WiMAX compliant wireless communication system, it should be appreciated that the techniques disclosed herein are broadly applicable to wireless communication systems that implement error control through re-transmissions of data, such as ARQ error control and HARQ error control, and that employ quality of service (QoS) classes. As used herein, the term “coupled” includes both a direct electrical connection between blocks or components and an indirect electrical connection between blocks or components achieved using intervening blocks or components. As is also used herein, the term “subscriber station” and “user equipment” are synonymous and are utilized to broadly denote a wireless communication device.

As noted above, in the prior art, a serving BS is incapable of specifying how many re-transmissions a connection should use, as the serving BS has been incapable of determining which connection an SS used for an allocation until successful receipt of transmitted data. According to the present disclosure, a technique is disclosed that provides a serving BS a priori knowledge of a re-transmission identifier, such as a HARQ channel identification (ACID) or an ARQ Identifier Sequence Number (AISN), used for a transmission/re-transmission. In this case, the re-transmission identifier belongs to a group of one or more re-transmission identifiers whose number of allocated re-transmissions is also known to the serving BS. In this manner, a serving BS can ensure that QoS parameters are met for a connection.

In order to optimize system efficiency and maximize user experience, a scheduler should generally ensure that latency/jitter requirements for time/jitter sensitive applications are met. For IEEE 802.16d/e, as well as other grant-per-SS technologies, a technique is needed to balance system requirements of connection-based QoS and SS allocation flexibility of SS-based grants. According to various aspects of the present disclosure, techniques are disclosed that efficiently utilize physical (PHY) layer resources to meet medium access control (MAC) level committed QoS. In this manner, BS performance is increased and end-to-end latencies for uplink data flows are decreased. According to the present disclosure, re-transmission identifiers, such as ACIDs, are assigned in a manner that facilitates BS control over usage of HARQ channels for UL flows. In this case, a scheduler can generally ensure that a UL flow is being used by an SS for a known purpose and, thus, maintain an appropriate QoS for the UL flow.

In a subscriber basic capability (SBC) procedure between a BS and an SS (during network entry of the SS before any connections are created), a maximum number of ACIDs that may be used between the BS and the SS is typically negotiated. At a later point, during flow creation, ACIDs used for a flow are selected through negotiation. In general, the selected ACIDs are a subset of the ACIDs known from the SBC procedure. In a conventional implementation, each ACID can be shared across multiple flows and each ACID can potentially go through the same maximum number of re-transmissions. According to at least one embodiment of the present disclosure, a technique is employed that generally prevents more re-transmissions than a connection can tolerate by dividing a pool of available ACIDs (during flow connection) into groups that have a different number of maximum re-transmission attempts that can be tolerated and still meet an application dependent latency/jitter requirement. While the discussion herein focuses on meeting application latency/jitter requirements (based on a maximum number of re-transmissions), it is contemplated that the techniques disclosed herein are broadly applicable to other QoS parameters.

According to one aspect of the present disclosure, a technique for operating a wireless communication device includes assigning re-transmission identifiers, such as automatic repeat request (ARQ) channel identifiers or hybrid automatic repeat request (HARQ) channel identifiers (herein collectively referred to as ACIDs) or ARQ Identifier Sequence Numbers (AISNs), to at least a first re-transmission identifier group and a second re-transmission identifier group, wherein each re-transmission identifier group is associated with a different quality of service parameter. The technique identifies whether a committed quality of service is met for a connection based on whether a communication on the connection is associated with the first group or the second group.

According to another aspect of the present disclosure, a wireless communication device includes a scheduler that is configured to assign re-transmission identifiers to at least a first re-transmission identifier group and a second re-transmission identifier group. The first and second re-transmission identifier groups are associated with different quality of service parameters. The scheduler is also configured to identify whether a committed quality of service is met for a connection based on whether a communication on the connection is associated with the first group or the second group.

According to a different aspect of the present disclosure, a wireless communication device includes a transceiver and a processor that is coupled to the transceiver. The processor is configured to assign re-transmission identifiers to at least a first re-transmission identifiergroup and a second re-transmission identifiergroup, wherein each re-transmission identifiergroup is associated with a different quality of service parameter. The processor is also configured to identify whether a committed quality of service is met for a connection based on whether a communication on the connection is associated with the first group or the second group.

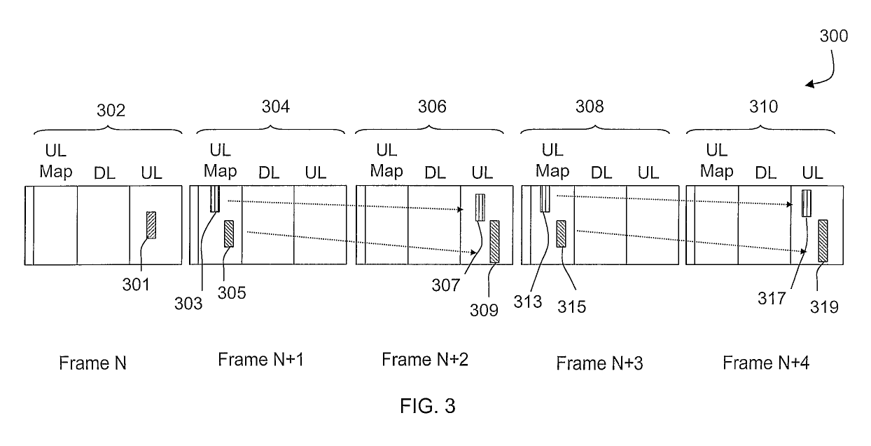

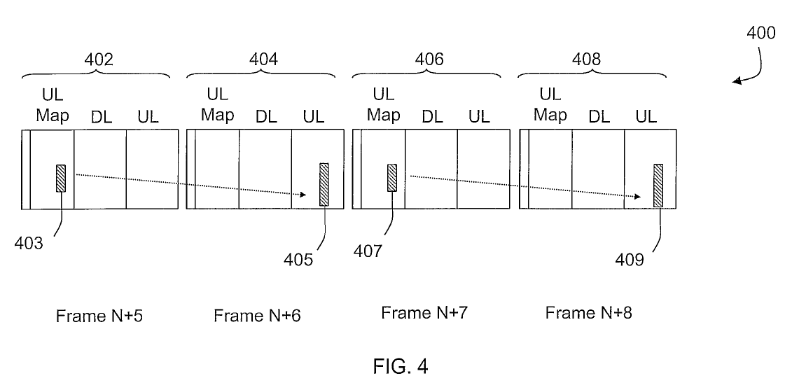

With reference to FIGS. 3 and 4, example diagrams 300 and 400 depict a series of communications between a subscriber station (SS) and a serving base station (BS) that are included within a wireless communication system that is configured according to the present disclosure. The system employs an error control procedure that involves re-transmissions of unacknowledged or negatively acknowledged data, such as data that is erroneously received or not received at all, for example, a HARQ error control procedure, and groups re-transmission identifiers, such as ACIDs and AISNs, based on quality of service (QoS) parameters. For example, re-transmission identifiers may be placed in groups that correspond to the maximum number of re-transmissions that can be initiated while meeting the QoS parameters. For example, ACIDs may be grouped during connection creation as follows: ACID 0, ACID 1, ACID 2, and ACID 3 may be allocated to jitter-intolerant connections that use zero HARQ re-transmissions; ACID 4, ACID 5, ACID 6, and ACID 7 may be allocated to less jitter-intolerant connections that use one HARQ re-transmission; ACID 8, ACID 9, ACID 10, and ACID 11 may be allocated to connections with intermediate jitter requirements that use two HARQ re-transmissions; and ACID 12, ACID 13, ACID 14, and ACID 15 may be allocated to jitter tolerant connections that use three HARQ re-transmissions. As another example, ACIDs may be grouped during connection creation as follows: ACID 0, ACID 1, ACID 2, ACID 3, ACID 4, ACID 5, ACID 6, and ACID 7 may be allocated to jitter/delay sensitive connections that use two or less HARQ re-transmissions; and ACID 8, ACID 9, ACID 10, ACID 11, ACID 12, ACID 13, ACID 14, and ACID 15 may be allocated to jitter/delay insensitive connections that use three or more HARQ re-transmissions.

As yet another example, ACIDs may be grouped during connection creation as follows: ACID 0 and ACID 1 may be allocated to jitter-intolerant connections that use zero HARQ re-transmissions; ACID 2, ACID 3, ACID 4, and ACID 5 may be allocated to less jitter-intolerant connections that use one HARQ re-transmission; ACID 6, ACID 7, ACID 8, ACID 9, and ACID 10 may be allocated to connections with intermediate jitter requirements that use two HARQ re-transmissions; and ACID 11, ACID 12, ACID 13, ACID 14, and ACID 15 may be allocated to jitter tolerant connections that use three HARQ re-transmissions. It should be appreciated that ACIDs may be grouped in two or more groups and more or less than sixteen ACIDs may be employed in a wireless communication system. When a stop-and-wait HARQ error control protocol is employed, connections generally do not require a large number (e.g., greater than four) of ACIDs due to the nature of the stop-and-wait HARQ error control protocol and fixed inter-arrival service data unit (SDU) rate.

In the example diagrams 300 and 400, the SS is executing a first wireless packet data application, such as a Voice over Internet Protocol (VoIP) application, and a second wireless packet data application, such as a web browsing application. However, implementation of any application involving a wireless transfer of packet data may be applicable here, such as file transfer, video, and so on. The SS has a basic CID of 1, all ACIDs (e.g., sixteen ACIDs) are assigned to respective groups that correspond to different QoS parameters, and the BS is configured to provide a maximum of one re-transmission for VoIP traffic, three re-transmissions for web browsing traffic, and four maximum re-transmissions. In a UL of a first frame 302, the BS receives a bandwidth request 301 from the SS for two connection identifiers (CIDs), i.e., a VoIP CID with a CID value 111 and a web browsing CID with a CID value 222. In a UL map of a second frame 304, the BS transmits a first allocation (HARQ subburst 1 for CID 111 having a basic CID 1; ACID 0; AISN 0) 303 for the VoIP CID 111 and a first allocation (HARQ subburst 2 for CID 222 having a basic CID 1; ACID 11; AISN 0) 305 for the web browsing CID 222. In this case, ACID 0 is assigned to an ACID group that uses one HARQ re-transmission and ACID 11 is assigned to another ACID group that uses three HARQ re-transmissions. In a UL of a third frame 206, the SS transmits UL data (for the VoIP CID 111) in a first grant 307 (allocated by the BS for the VoIP CID 111) and UL data for the web browsing CID 222 in a first grant 309 (allocated by the BS for the web browsing CID 222), as the SS is limited to sending UL data for the VoIP CID 111 and the web browsing CID 222 in the grants 307 and 309, respectively.

Assuming that the UL data for the VoIP CID 111 and the web browsing CID 222 are received by the BS with CRC errors, the BS provides a second allocation 313 for the VoIP CID 111 and a second allocation 315 for the web browsing CID 222 in a UL map of a fourth frame 308. In a UL of a fifth frame 310, the SS re-transmits UL data for the VoIP CID 111 in a second grant 317 and re-transmits UL data for the web browsing CID 222 in a second grant 319. Assuming that the UL data for the VoIP CID 111 and the web browsing CID 222 are again received by the BS with CRC errors, the BS provides a third allocation 403 for the web browsing CID 222 in a UL map of a sixth frame 402 and abandons further re-transmissions for the VoIP CID 111, as the BS knows that the SS transmitted the UL data for the VoIP CID 111 in the grant for the VoIP CID 111. In a UL of a seventh frame 404, the SS again re-transmits UL data for the VoIP CID 111 in a third grant 405. Assuming that the UL data for the web browsing CID 222 is again received with CRC errors, the BS provides a fourth allocation 407 for the web browsing CID 222 in a UL map of an eighth frame 406. As is illustrated, in a UL of a ninth frame 408, the SS again re-transmits UL data for web browsing CID 222 in a fourth grant 409. Assuming that the UL data for the web browsing CID 222 is received without error, the BS has maintained a committed QoS for the web browsing CID 222, as well as the VoIP CID 111.

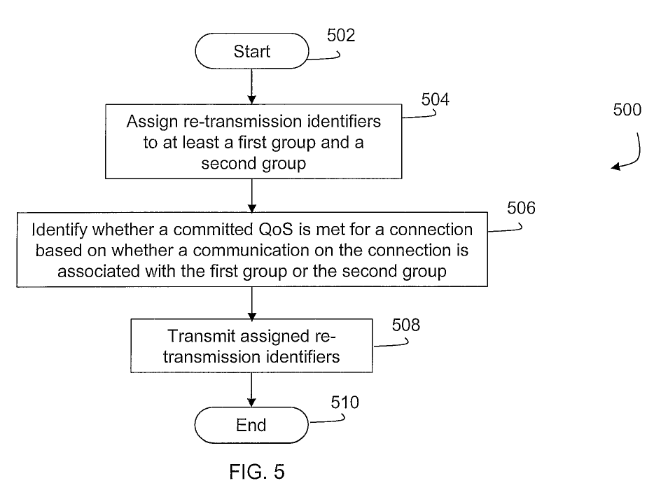

Referring now to FIG. 5, an example process 500 is illustrated that is employed at a serving base station (BS) to determine whether a committed quality of service (QoS) is being met for a connection in a wireless communication system. In block 502 the process 500 is initiated, at which point control transfers to block 504. In block 504, the BS (or a scheduler associated with the BS) assigns multiple re-transmission identifiers, such ACIDs and AISNs, to at least a first re-transmission identifier group and a second re-transmission identifier group that are each associated with different QoS parameters. As noted above, re-transmission identifiers may be assigned to more than two groups depending upon how many QoS classes are warranted for a particular situation. Moreover, the number of groups and the re-transmission identifiers assigned thereto may change over time. Next, in block 506, the serving BS (or the scheduler associated with the BS) identifies whether a committed QoS is met for a connection based on whether a communication on the connection is associated with the first group or the second group. Then, in block 508, the BS transmits the re-transmission identifier during connection creation or in a broadcast message that is provided in a UL map. Following block 508, the process 500 terminates in block 510 and control returns to a calling process.

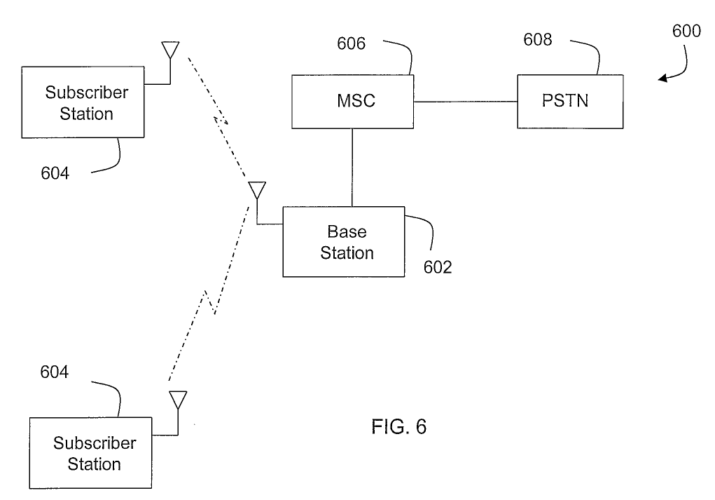

With reference to FIG. 6, an example wireless communication system 600 includes multiple subscriber stations (SSs) 604, e.g., mobile stations (MSs), that are configured to communicate with a remote device (not shown) via a serving base station (BS) 602. In various embodiments, the system 600 is configured to maintain a quality of service of a connection based on an assignment of a re-transmission identifier to a re-transmission identifier group. Each SS 604 may transmit/receive various information, e.g., voice, images, video, and audio, to/from various sources, e.g., another SS, or an Internet connected server. As is depicted, the BS 602 is coupled to a mobile switching center (MSC) 606, which is coupled to a public switched telephone network (PSTN) 608. Alternatively, the system 600 may not employ the MSC 606 when voice service is based on Voice over Internet Protocol (VoIP) technology, where calls to the PSTN 608 are typically routed through a gateway (not shown).

The BS 602 includes a transmitter and a receiver (not individually shown), both of which are coupled to a control unit (not shown), which may be, for example, a microprocessor, a microcontroller, a programmable logic device (PLD), or an application specific integrated circuit (ASIC) that is configured to execute a software system to perform at least some of the various techniques disclosed herein. Similarly, the SSs 604 include a transmitter and a receiver (not individually shown) coupled to a control unit (not shown), which may be, for example, a microprocessor, a microcontroller, a PLD, or an ASIC that is configured to execute a software system to perform at least some of the various techniques disclosed herein. The control unit may also be coupled to a display (e.g., a liquid crystal display (LCD)) and an input device (e.g., a keypad).

Accordingly, techniques have been described herein that allow a BS to maintain a committed QoS for all applications by allocating available re-transmission identifiers, such as ACIDs and AISNs, (from a pool of re-transmission identifiers) to re-transmission identifier groups based on QoS parameters. In employing the disclosed techniques, a serving BS essentially implements a QoS-based grant procedure, as opposed to an SS-based grant procedure. This allows an SS to choose among connections with the same QoS constraints. According to various aspects of the present disclosure, a re-transmission identifier assignment is sent to an SS during connection creation. In addition, usage of the assigned re-transmission identifiers may be broadcast in UL maps transmitted from the BS to the SS in a downlink portion of a frame whenever data is transmitted for an associated flow. In summary, the present disclosure provides techniques that substantially maintain committed QoS (e.g., maximum latency, tolerated jitter, etc.) for a connection that is associated with a wireless packet data application (e.g., a time-sensitive application such as a gaming application or Voice over Internet Protocol (VoIP) application) while still facilitating implementation of packet data re-transmission, such as HARQ, error control procedures.

As used herein, a software system can include one or more objects, agents, threads, subroutines, separate software applications, two or more lines of code or other suitable software structures operating in one or more separate software applications, on one or more different processors, or other suitable software architectures.

As will be appreciated, the processes in preferred embodiments of the present invention may be implemented using any combination of computer programming software, firmware or hardware. As a preparatory step to practicing the invention in software, the computer programming code (whether software or firmware) according to a preferred embodiment is typically stored in one or more machine readable storage mediums, such as fixed (hard) drives, diskettes, optical disks, magnetic tape, semiconductor memories (e.g., read-only memories (ROMs), programmable ROMs (PROMs), etc.), thereby making an article of manufacture in accordance with the invention. The article of manufacture containing the computer programming code is used by either executing the code directly from the storage device, by copying the code from the storage device into another storage device, such as a hard disk, random access memory (RAM), etc., or by transmitting the code for remote execution. The method form of the invention may be practiced by combining one or more machine-readable storage devices containing the code according to the present disclosure with appropriate standard computer hardware to execute the code contained therein.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included with the scope of the present invention. Any benefits, advantages, or solution to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

1. A method of operating a wireless communication device, comprising:
assigning re-transmission identifiers to at least a first re-transmission identifier group and a second re-transmission identifier group, wherein the first and second re-transmission identifier groups are associated with different quality of service parameters; and
identifying whether a committed quality of service is met for a connection based on whether a communication on the connection is associated with the first re-transmission identifier group or the second re-transmission identifier group.

2. The method of claim 1, wherein the first re-transmission identifier group is associated with a first wireless packet data application and the second re-transmission identifier group is associated with a second wireless packet data application.

3. The method of claim 2, wherein one of the first and second wireless packet data applications is a Voice over Internet Protocol application and the other of the first and second wireless packet data applications is a web browser application.

4. The method of claim 1, wherein the first re-transmission identifier group employs a different maximum number of maximum re-transmissions than the second re-transmission identifier group.

5. The method of claim 1, further comprising:
transmitting, from a base station to a subscriber station, the assigned re-transmission identifiers during service flow creation.

6. The method of claim 1, further comprising:
transmitting, from a base station to a subscriber station, the assigned re-transmission identifiers in a broadcast message.

7. The method of claim 6, wherein the broadcast message is provided in an uplink map of a downlink subframe.

8. A wireless communication device, comprising:
a scheduler configured to:
assign re-transmission identifiers to at least a first re-transmission identifier group and a second re-transmission identifier group, wherein the first and second re-transmission identifier groups are associated with different quality of service parameters; and
identify whether a committed quality of service is met for a connection based on whether a communication on the connection is associated with the first re-transmission identifiers group or the second re-transmission identifier group.

9. The wireless communication device of claim 8, wherein the first re-transmission identifier group is associated with a first wireless packet data application and the second re-transmission identifier group is associated with a second wireless packet data application.

10. The wireless communication device of claim 9, wherein one of the first and second wireless packet data applications is a Voice over Internet Protocol application and the other of the first and second wireless packet data applications is a web browser application.

11. The wireless communication device of claim 8, wherein the first re-transmission identifier group employs a different maximum number of re-transmissions than the second re-transmission identifier group.

12. The wireless communication device of claim 8, further comprising:
a base station coupled to the scheduler, wherein the base station is configured to transmit, to a subscriber station, the assigned re-transmission identifiers during service flow creation.

13. The wireless communication device of claim 8, further comprising:
a base station coupled to the scheduler, wherein the base station is configured to transmit the assigned re-transmission identifiers in a broadcast message.

14. The wireless communication device of claim 13, wherein the broadcast message is provided in an uplink map of a downlink subframe.

15. A wireless communication device, comprising:
a transceiver; and
a processor coupled to the transceiver, wherein the processor is configured to:
assign re-transmission identifier to at least a first re-transmission identifier group and a second re-transmission identifier group, wherein the first and second re-transmission identifier groups are associated with different quality of service parameters; and
identify whether a committed quality of service is met for a connection based on whether a communication on the connection is associated with the first re-transmission identifier group or the second re-transmission identifier group.

16. The wireless communication device of claim 15, wherein the first re-transmission identifier group is associated with a first wireless packet data application and the second re-transmission identifier group is associated with a second wireless packet data application.

17. The wireless communication device of claim 16, wherein one of the first and second wireless packet data applications is a Voice over Internet Protocol application and the other of the first and second wireless packet data applications is a web browser application.

18. The wireless communication device of claim 15, wherein the first re-transmission identifier group employs a different maximum number of re-transmissions than the second re-transmission identifier group.

19. The wireless communication device of claim 15, wherein the processor is further configured to transmit, using the transceiver, the assigned re-transmission identifiers to a subscriber station during service flow creation.

20. The wireless communication device of claim 15, wherein the processor is further configured to transmit the assigned re-transmission identifiers in a broadcast message that is provided in an uplink map of a downlink subframe.
